(19) United States
(12) Patent Application Publication
(10) Pub. No.: US 2026/0351801 A1
(43) Pub. Date: Nov. 5, 2026

(54) Drive Battery for a Motor Vehicle

(71) Applicant: Bayerische Motoren Werke Aktiengesellschaft, Muenchen (DE)

(72) Inventors: Matthias FRANK, Muenchen (DE); Philip KOTTER, Muenchen (DE)

(21) Appl. No.: 19/102,599

(22) PCT Filed: Aug. 28, 2023
(86) PCT No.: PCT/EP2023/073476

§ 371 Date: Feb. 10, 2025

(30) Foreign Application Priority Data
Sep. 23, 2022 (DE) 10 2022 124 457.1

(51) Int. Cl. H01M 50/503; H01M 50/249; H01M 50/516; H01M 50/524; H01M 50/583

(52) U.S. Cl. CPC H01M 50/503; H01M 50/249; H01M 50/516; H01M 50/524; H01M 50/583; H01M 2220/20

(57) ABSTRACT

A drive battery for a motor vehicle has multiple accumulator cells, a cell connector that electrically interconnects the accumulator cells, and an installation board which is mounted on the accumulator cells and accommodates the cell connector. The cell connector has an undulation which is mounted on a rib of the installation board, and a gap between the undulation and the rib of the installation board is less than 1 mm.

### BACKGROUND AND SUMMARY

The present disclosure relates to a drive battery for a motor vehicle, and to a motor vehicle having the drive battery.

A drive battery (also referred to as a high-voltage battery, traction battery or cycle battery) is a rechargeable battery which is primarily intended to supply the electric motors used for propulsion in electric vehicles with electrical energy. These also include the buffer batteries in fuel cell vehicles and in hybrid drives.

Such drive batteries have a few to thousands of rechargeable-battery cells or cell blocks that are interconnected in parallel and series. To interconnect or electrically connect the individual rechargeable-battery cells, use is made of so-called cell connectors or busbars.

In this connection, DE 10 2009 050 316 A1 proposes, in order to create a cell connector for electrically conductively connecting a first cell terminal of a first electrochemical cell and a second cell terminal of a second electrochemical cell of an electrochemical device, which allows reliable and fail-safe connection of the cell terminals, that the cell connector comprise a first contact portion for connecting to the first cell terminal, a second contact portion for connecting to the second cell terminal, and an elastically and/or plastically deformable compensation region which connects the first contact portion and the second contact portion together and allows these contact portions to move relative to one another.

DE 10 2018 219 478 A1 describes a method for cohesively connecting a terminal of a battery cell to at least one cell connector by means of resistance welding, wherein an electrically conductive first cell connector is placed on the terminal of the battery cell, and a first welding electrode is placed on the first cell connector, and a second welding electrode is brought into electrical contact with the terminal such that a welding current flows from the first welding electrode, through the first cell connector and through the terminal, to the second welding electrode, with the result that the first cell connector is connected to the terminal of the battery cell by means of resistance welding.

Against the background of this prior art, the present disclosure addresses the problem of providing a device which is suitable for enhancing the prior art.

This problem is solved by the features of the independent claim. The dependent claims and the additional independent claim contain optional developments of the invention.

Accordingly, the problem is solved by a drive battery for a motor vehicle. This can be a generic drive battery as described at the beginning. It is contemplated for the drive battery to be able to provide voltages in a range from 400 V to 800 V.

The drive battery comprises a plurality of rechargeable-battery cells, a cell connector which connects the rechargeable-battery cells electrically together, and an installation board which is fitted on the rechargeable-battery cells and receives the cell connector.

The rechargeable-battery cells can be understood as being electrochemical cells which are configured to be repeatedly charged by means of electrical energy, to store this energy, and to discharge the stored energy during operation of the drive battery.

The cell connector is a component produced from electrically conductive material, which connects the individual rechargeable-battery cells in series and/or in parallel with one another.

The installation board may be a component that is produced from plastic, for example by means of injection-molding, and is therefore not conductive. The installation board serves, during the installation of the drive battery, to position the cell connector relative to the rechargeable-battery cells. During operation of the drive battery, the installation board mechanically supports the cell connector.

The cell connector has an undulation which is mounted on a rib of the installation board.

In other words, the cell connector has, with the undulation, an element of reduced stiffness, which serves to compensate for tolerances and operating loads (cell swelling, vibration, thermal expansion). The undulation therefore reduces the forces that act on the connecting point with the cell (for example a weld seam).

The undulation can be understood as being a portion in which the cell connector has a substantially U-shaped cross section.

A gap between the undulation and the rib of the installation board is smaller than 1 mm, optionally smaller than 0.5 mm or smaller than 0.3 mm.

The gap between the undulation and the installation board is thus small enough that, during foam-coating of the drive battery, no foam passes or flows between the undulation and the installation board and then hardens between the two components. Thus, mechanical self-protection of this subregion, which is delicate compared with the rest of the cell connector, can be achieved, since no mechanical connection of the cell connector to the installation board is established there.

Possible developments of the above-described drive battery are explained in detail in the following text.

The cell connector may have, in the region of the undulation, a cross-sectional narrowing, in order in this way to form a fuse. Thus, propagation of a so-called “thermal runaway” between the cells can be avoided during operation of the drive battery.

The cross-sectional narrowing may be formed by a through-hole in the region of the undulation. This is a space-saving solution for forming the fuse.

In particular, the installation board may have a cuboidal block which is arranged in the through-hole and projects beyond the undulation in a direction that is perpendicular to the rechargeable-battery cells.

This block of the installation board may, accordingly, project in a space-saving manner through the opening in the undulation, which can also be referred to as a fuse, and may thus protect these mechanically relatively sensitive components from loads.

A gap between the undulation and the cuboidal block of the installation board may be smaller than 1 mm.

Thus, this gap between the undulation and the installation board is also small enough that, during foam-coating of the drive battery, no foam passes or flows between the undulation and the block of the installation board and then hardens between the two components. Thus, the above-described mechanical self-protection of this subregion, which is delicate compared with the rest of the cell connector, can continue to be achieved, since no mechanical connection of the cell connector to the installation board is established here either.

The cross-sectional narrowing may have dimensions such that the undulation reaches a temperature of greater than 80 °C, optionally greater than 100 °C, during operation of the drive battery.

At the fuse or undulation, as a result of these high temperatures, the mechanical properties of the material of the cell connector can be favorably reduced, since the material becomes softer here and thus less load acts on the connecting points of the cell connector with the respective cell. In addition, as a result of these temperatures, material phenomena can occur, which can have a further positive influence on the mechanical performance and lifetime. For example, increased creep tendencies can result, with the result that mechanical tensions in particular due to long-term changes (for example tolerances and swelling) can be reduced. The small cross sections in the region of the undulation can additionally increase the effectiveness of the undulation as a compensation element.

The drive battery may have a housing and a polymer foam, with which the cell connector is foam-coated with regard to the housing.

In other words, the rechargeable-battery cells and/or the cell connector may be foam-coated with regard to the (high-voltage battery) housing. In particular in combination with the undulation, which reaches the high temperatures (for example greater than 100 °C to 150 °C) during operation, it is possible, with the drive battery according to the disclosure, for a potentially and/or partially adhering foam to be, so to speak, freely burned or melted. This means that the foam loses its mechanical properties (for example starting from the glass transition temperature of polyurethane materials at about 80 °C). As a result, the undulation can protect itself from such unfavorable, additional mechanical load inputs.

It is contemplated for a gap between the undulation and the housing to have the above-described gap dimensions, i.e. to be smaller than 1 mm, optionally smaller than 0.5 mm or smaller than 0.3 mm.

Thus, this gap between the undulation and the housing, in particular a housing upper part, is also small enough that, during foam-coating of the drive battery, no foam passes or flows between the undulation and the housing and then hardens between the two components. Thus, the above-described mechanical self-protection of this subregion, which is delicate compared with the rest of the cell connector, can continue to be achieved, since no mechanical connection of the cell connector to the housing is established here either.

The cell connector may be welded to the individual rechargeable-battery cells. It is contemplated for the installation board to be produced from a plastic.

Also provided is a motor vehicle which has an above-described drive battery.

The motor vehicle may be a single-track or two-track vehicle. The motor vehicle may be a passenger car, for example an automobile, and/or a commercial vehicle, for example a truck.

The drive battery may be connected to an electric motor of the motor vehicle and be configured to supply the vehicle with electrical energy during operation of the drive battery. The electric motor may be configured to drive the motor vehicle by means of the electrical energy obtained from the drive battery.

The description given above with regard to the drive battery also applies analogously to the motor vehicle and vice versa.

In the following text, an embodiment is described with reference to FIG. 1.

### BRIEF DESCRIPTION OF THE DRAWING

FIG. 1 schematically shows, in a plan view, a drive battery for a motor vehicle, wherein a subregion of the drive battery is illustrated in an enlarged manner for explanatory purposes.

### DETAILED DESCRIPTION OF THE DRAWING

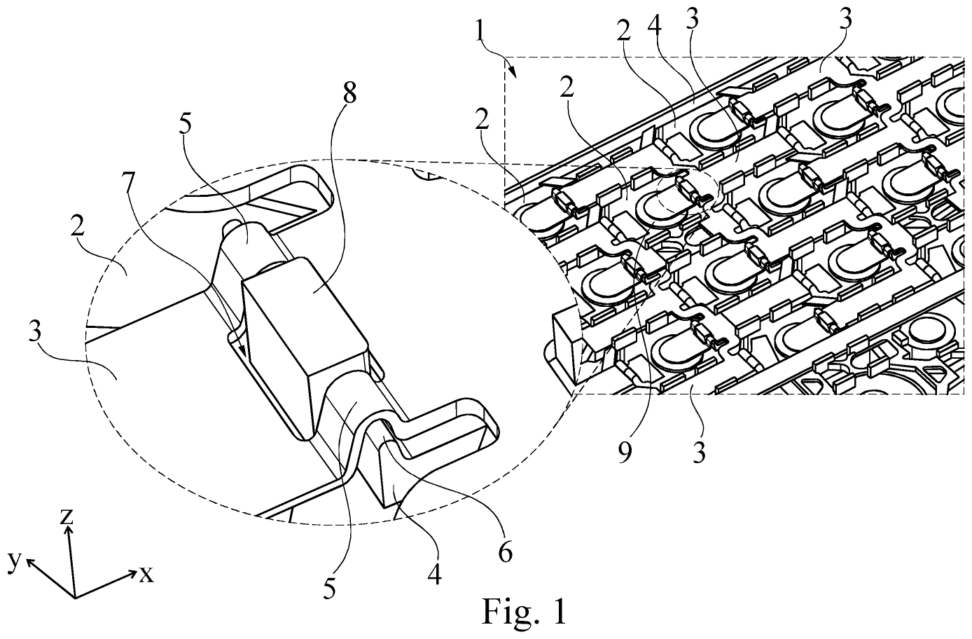

Illustrated in FIG. 1 is a Cartesian coordinate system, the X-axis of which extends along a motor vehicle longitudinal direction X, the Y-axis of which extends along a motor vehicle widthwise direction Y, and the Z-axis of which extends along a motor vehicle vertical direction Z. The three axes or directions are respectively perpendicular to one another. The motor vehicle longitudinal direction X and the motor vehicle widthwise direction Y define a substantially horizontal plane to which the motor vehicle vertical direction Z, which extends substantially parallel to a vertical line, is perpendicular. The motor vehicle longitudinal direction X extends from a front to a rear of the motor vehicle (not illustrated in more detail).

As is apparent from the plan view on the right in FIG. 1, the drive battery 1 for the motor vehicle comprises a plurality of rechargeable-battery cells 2, a plurality of cell connectors 3, which respectively connect the rechargeable-battery cells 2 electrically together, and an installation board 4, embodied as a injection-molded plastics part, which is fitted on the rechargeable-battery cells 2 and which receives the cell connectors 3.

As is apparent in particular from the left-hand illustration in FIG. 1, which illustrates a detail of the drive battery 1 in an enlarged manner, the cell connector 3 has, for each connecting point 9 (in the present case a welded connection) with one of the rechargeable battery cells 2, an undulation or a wavelike portion 5, which is mounted on a rib 6 of the installation board 4.

In order to mechanically decouple the undulation 5 and thus the cell connector 3, in the portion in which the undulation 5 is formed, from the rib 6 and thus from the installation board 4, a surrounding gap is provided between the undulation 5 and the rib 6 of the installation board 4, with this gap creating a spacing of less than 1 mm between the rib 6 and the undulation 5, however.

The cell connector 3 has, in the region in which the undulation 5 is formed, a through-hole 7, with the result that, in this region, there is a cross-sectional narrowing of the cell connector 3 in the motor-vehicle widthwise direction Y, and the region in which the undulation 5 is formed serves as a fuse.

A substantially cuboidal block 8, as part of the installation board 4, is formed in a space-saving manner in the through-hole 7, and projects beyond the undulation 5 in the motor-vehicle vertical direction Z, thus preventing or at least reducing load input from above onto the undulation 5.

In the same way as with respect to the rib 6, a gap is also formed between the undulation 5 and the cuboidal block 8 of the installation board 4, this gap being smaller than 1 mm and mechanically decoupling the undulation 5 from the block 8 of the installation board 4.

The above-described drive battery 1 is provided, during installation, with a housing (not illustrated), and a liquid polymer foam, comprising, for example, polyurethane, is introduced between the housing, in particular an upper part of the housing, and the drive battery 1, this foam expanding and hardening. On account of the small gap size between the undulation 5 and the rib 6 and, respectively, the block 8 of the installation board 4, no polymer foam passes into these gaps and the mechanical decoupling remains even after foam-coating. It is also contemplated to choose a gap between the undulation 5 and the housing, as described above, i.e. smaller than 1 mm, such that no polymer foam passes between the undulation 5 and the housing either, and mechanical decoupling exists here too.

This mechanical decoupling relieves the load, inter alia, on the cell connector 3, and component failure during subsequent operation of the motor vehicle can be avoided. In order to additionally ensure the mechanical decoupling, the through-hole 7 forming the cross-sectional narrowing has such dimensions that, during operation of the drive battery 1, the undulation reaches a temperature greater than 80 °C. As a result, the polymer foam substantially loses its adhesive power in the region of the undulation 5 and the undulation 5 is mounted in an exposed manner in the polymer foam.

### LIST OF REFERENCE SIGNS

1 Drive battery
2 Rechargeable-battery cells
3 Cell connector
4 Installation board
5 Undulation
6 Rib
7 Through-hole
8 Block
9 Connecting point
X Motor-vehicle longitudinal direction
Y Motor-vehicle widthwise direction
Z Motor-vehicle vertical direction.

1-10. (canceled)

11. A drive battery for a motor vehicle, comprising:
a plurality of rechargeable-battery cells;
a cell connector which connects the rechargeable-battery cells electrically together; and
an installation board which is fitted on the rechargeable-battery cells and receives the cell connector, wherein
the installation board has a rib,
the cell connector has an undulation which is mounted on the rib of the installation board, and
a gap between the undulation and the rib of the installation board is less than 1 mm.

12. The drive battery according to claim 11, wherein
the cell connector has, in a region of the undulation, a cross-sectional narrowing, in order to form a fuse.

13. The drive battery according to claim 12, wherein
the cross-sectional narrowing is formed by a through-hole in the region of the undulation.

14. The drive battery according to claim 13, wherein
the installation board has a cuboidal block, which cuboidal block is arranged in the through-hole and projects beyond the undulation in a direction that is perpendicular to a plane of the rechargeable-battery cells.

15. The drive battery according to claim 14, wherein
a gap between the undulation and the cuboidal block of the installation board is less than 1 mm.

16. The drive battery according to claim 12, wherein
the cross-sectional narrowing has dimensions such that the undulation reaches a temperature of greater than 80 °C during operation of the drive battery.

17. The drive battery according to claim 11, further comprising:
a housing; and
a polymer foam, with which the cell connector is foam-coated with regard to the housing.

18. The drive battery according to claim 11, wherein
the cell connector is welded to individual ones of the plurality of rechargeable-battery cells.

19. The drive battery according to claim 11, wherein
the installation board is made of a plastic.

20. A motor vehicle comprising a drive battery according to claim 11.
